(19) United States
(12) Patent Application Publication
(10) Pub. No.: US 2019/0248286 A1
(43) Pub. Date: Aug. 15, 2019

(54) DEVICE TO REMIND RESPONSIBLE PERSON OF ITEMS OR PERSONS INADVERTENTLY OVERLOOKED

(71) Applicants: Russelle Lane Maxwell, Pueblo, CO (US); Margaret Rose Maxwell, Pueblo, CO (US); Robert Johnson, Pueblo, CO (US)

(72) Inventors: Russelle Lane Maxwell, Pueblo, CO (US); Margaret Rose Maxwell, Pueblo, CO (US); Robert Johnson, Pueblo, CO (US)

(21) Appl. No.: 15/895,268

(22) Filed: Feb. 13, 2018

(51) Int. Cl. B60Q 9/00; B60N 2/00; B60N 2/26

(52) U.S. Cl. CPC B60Q 9/00; B60N 2/26; B60N 2/002

(57) ABSTRACT

The present invention is a device which can be readily installed into a vehicle in order to provide a reminder to a caregiver that there is a child, handicapped person, pet, or other item in the vehicle which needs to be removed when he/she exits the vehicle. The invention also provides the same protection for additional occupants. Additionally, the invention includes a provision for an alarm if the child frees himself from his seat while the caregiver is still in his or her seat

### CROSS REFERENCE TO RELATED APPLICATIONS

This application claims the benefit of U.S. Provisional Application No. 62/606,913 dated Oct. 12, 2017. The aforementioned application is incorporated herein by reference in its entirety to provide continuity of disclosure.

A search of pertinent literature also reveals two official studies that discuss, test, and evaluate several systems of child safety devices. Some of these were available at the time, while others were in various stages of development. These studies were: National Highway Traffic Safety Administration report DOT HS 811 632 titled “Reducing the Potential for Heat Stroke to Children in Parked Motor Vehicles: Evaluation of Reminder Technology” dated July 2012; and National Highway Traffic Safety Administration report DOT HS 812 187 titled “Functional Assessment of Unattended Child Reminder Systems” dated July 2015. Both reports pointed out that there were some serious drawbacks to many of the systems tested and/or evaluated.

### STATEMENT OF FEDERALLY FUNDED RESEARCH

No federal funds were used in the conception or development of this invention.

### JOINT RESEARCH AGREEMENT

No joint research agreement was used in the conception or development of this invention.

### COMPUTER PROGRAM LISTING

The microprocessor/computer/control logic employed will depend on the individual Inputs and outputs of the end product and use of this invention.

### CLASSIFICATIONS

### CCURRENT U.S. CLASS: 340/457; 180/272; 340/522; 340/573.1; 340/667

### CURRENT CPC CLASS: G08B 21/02 (20130101); B60R 21/01516 (20141001)

### CURRENT INTERNATIONAL CLASS: 1360Q 1/001 (20060101)

### FIELD OF SEARCH: 340/457,573.1,573.4,425.5,667,522;180/272,273,271,290

### FIELD OF THE INVENTION

This invention lies in the field of child safety. Specifically, it relates to a means by which to remind a caregiver that a child, handicapped person, pet, or other item in the vehicle must not be overlooked.

### DESCRIPTION

### Cross Reference to Related Applications

This application claims the benefit of U.S. Provisional Application Ser. No. 2/606,913 dated Oct. 12, 2017. The aforementioned application is incorporated herein by reference in its entirety to provide continuity of disclosure.

A search of pertinent literature also reveals two official studies that discuss, test, and evaluate several systems of child safety devices. Some of these were available at the time, while others were in various stages of development. These studies were: National Highway Traffic safety Administration report DOT HS 811 632 titled “Reducing Potential Heat Stroke to Children in Parked Motor Vehicles: Evaluation of reminder Technology” dated July, 2012, and National Highway Traffic safety Administration report DOT HS 812 187 titled “Functional Assessment of Unattended Child Reminder Systems” dated July, 2015.

Both reports pointed out that there were some serious drawbacks to many of the systems tested and/or evaluated.
Glossary of Terms—The terms used in this application can be construed to include the following meanings:
Alerting Device or Alarm—Any form of enunciator alarm, voice recording, musical tone, light, or other form of attention-getting means.
Caregiver—Term interchangeable with driver or person wanting to be reminded of some person or item.
Controller—That “black box” containing the logic equipment required to operate the device. The control circuitry may be designed specifically for the child seat or may use a microprocessor for updating or versatility.
Occupant—Any infant, child, or person, or animal, or inanimate object who, (or which) is sitting or has been placed on one or more of the pressure sensing pads.
Pad—The seat device which is used to detect the presence of a person or object by completing or opening a circuit to the controller.
Power Supply—In the preferred embodiment of the invention, the power supply is a rechargeable 9 volt battery and the auxiliary power supplies may be the vehicle cigarette lighter socket, a USB port, a house electrical outlet with appropriate adapter, or similar means.

### DESCRIPTION OF THE PRIOR ART

A search of patents and applications related to children who are forgotten in vehicles reveals too many to list. However, it is possible to categorize examples by the method in which the reminder devices operate.

First, and simplest, are ones which employ stickers, placards, or items which are moved or placed as reminders that there is a child on board. Typical of these are U.S. Pat. Nos. 6,847,302, 9,547,976, and 7,726,736 as well as application US 20160016520. While these are inexpensive, and generally effective, they have no bearing on the present invention.

Second is a category which requires modifications to the child car seat such as those found in U.S. Pat. Nos. 8,063,788, and 8,058,983 and US patent applications 20060273917, 20080036581, and 20080055064, and Canadian CA2614906. The invention described herein requires no seat modifications.

In the third case, there are the devices which require slight modifications to the vehicle, such as adding sensors or connecting to the vehicle electrical system. Examples are taught in U.S. Pat. Nos. 6,909,365 and 9,536,416, and German DE102004044220, and US applications 20070268119 and 20060132293. In addition to burdening the the user with unnecessary inconvenience and expense, the unit is now only useful on vehicles modified in the same manner. The invention described herein requires no modifications to any vehicle.

Fourth, and even more costly and limiting in transferrability, are inventions like U.S. Pat. Nos. 8,190,332, 8,970,362, 6,870,472, and 7097226; Israeli Patent Application No. 180462 and US patent applications 20160042616, 20070052529 and 20040239183. These require extensive modifications to the vehicle, up to and including OEM accessories. For a young family with small children (the target consumer for these inventions), the cost is probably prohibitive. The present invention can be used on any vehicle and can even be transferred to a rental car for a traveling family.

The fifth category includes the many devices which depend on wireless, cell phone, RF devices, and the like. U.S. Pat. Nos. 8,058,983, 7,817,038, 7,592,905, US patent applications 20070222622, and 20150130604, and Italian patents WO2015118569 and WO2009079477, and European EP3154037 are typical of these. While many are well thought out, and very useful, they are subject to problems such as depleted batteries, loss of signal, phones which are turned off, etc. The use of wireless systems may serve to reduce the reliability and increase the cost of such a necessary invention. Then, too, these devices require the caregiver to exit the vehicle, as opposed to the present invention which alerts him/her as soon as he/she leaves the seat.

The sixth and final category contains the inventions which teach the use of hi-tech sensors such as motion, heat, audio, optical, radar and even more exotic sensors. Cited among these are U.S. Pat. Nos. 6,922,147, 6,353,394, 9,865,150 and US patent applications 20060103516, 20130194089. It is apparent to even a casual observer that such devices are overkill to a system that can rely on more conventional means to detect the presence of a child. All these detectors do is add to the complexity and cost of the unit.

The most salient feature of the present invention is ease of removal from one vehicle and installation into another—i.e. portability. U.S. Pat. No. 7,339,463 allows for the inclusion of a “dead man switch” which, if used and inadvertantly left in place, would prevent the unit from functioning in its prescribed manner. U.S. Pat. No. 5,949,340 and US patent application 20070132571 may in fact be portable, but call for an alarm to sound for the entire duration between the time the child is placed in his/her seat until the driver takes his or her seat. This annoyance can last an unacceptable length of time and has been reported to upset the child. US patent applications 20140266662 and 20080143544 both tout portability, but go on to recommend access to the vehicle wiring via the ignition, door switch, or the dome light. Any system that requires even the slightest access to vehicle systems cannot meet the test of total transferrability.

### BACKGROUND OF THE INVENTION

There have been far too many accounts of deaths of children, infirmed, handicapped people or pets who have inadvertently been forgotten and left in hot or freezing vehicles. Tragically, such negligence results in an average of 38 deaths a year. Undoubtedly, there have been countless other instances of unreported last minute rescues of such unfortunates (these statistics are not readily available).

Additionally, whom of us has not gone off in haste and forgotten important items such as a briefcase or groceries from home or car. This invention serves to remind individuals that some person or important item has almost been forgotten.

Many of the aforementioned accidents have occurred because of distracted drivers or because the driver is not the person who normally takes the child to daycare, etc., and he/she forgets that there is a child on board. In these cases, too, he/she is likely to be using the family's second car; the one that is not already equipped with some sort of a reminder device. The most salient feature of the present invention is ease of removal from one vehicle and installation into another—i.e. transferrability.

There are additional problems in that children can free themselves from their seats or that the seat pads can slip out of position. The present invention has a provision to alarm in either event while the vehicle is in motion.

### SUMMARY OF THE INVENTION

A visit to the marketplace reveals that there are very few devices available to solve the problem of forgotten persons or items in vehicles. Also, the few that are on the market typically require some modifications to the vehicle, smart phones, or other capabilities that an alternate driver may lack. The present invention proposes to fulfill the need for a reminder device which is user friendly, versatile, self-contained, light weight, transportable, reliable, compact, and above all, economical enough for a young, possibly financially strapped family to afford it.

The present embodiment of this invention consists primarily of two pressure sensitive pads, one for the child's car seat and one for the caregiver's seat, which are connected to a control unit which in turn contains or connects to a warning device. Having only these three major components, it is a stand-alone device which does not require any modifications to either the vehicle or the child's car seat. As such, it can easily be transferred from one vehicle to another. Additional pads can be added to accommodate other persons or items.

In its present embodiment of the invention, the primary use is to alert a driver or caregiver that there is at least one child in a car seat, and that he/she needs to retrieve the child when he/she exits his/her seat. Unlike the devices which allow the driver to walk away from the vehicle, the present invention alerts him/her immediately when he/she leaves the seat. Further, it will alert the caregiver if the child escapes from the car seat while the caregiver is in his/hers.

It will be evident to even a casual observer that it can also be used to remind of handicapped persons, pets or inanimate objects.

### BRIEF DESCRIPTION OF THE DRAWINGS

FIG. 1 is a rendering of the principal components of the invention and their relationship to each other. The controller [1] has wires [303] connecting it to the child's seat pad [2], the driver's seat pad, [3], and the auxiliary power supply such as the vehicle cigarette lighter, USB, etc.[4] and an indicator light [302]. It also shows the optional temperature sensor [5] plugged into its jack. The extra sensor pads [101, 102. 103, 104] which are used for a second child, other occupants, pets, or inanimate objects are shown not plugged in.

FIG. 2 is a block diagram of the major parts of the invention consisting of: [1] the microprocessor control unit, [2] the child's seat pad, [3] the driver's seat pad [4], a vehicle cigarette lighter or auxiliary power receptacle, and [5] a temperature sensor with a digital display. Other inputs to the control unit [1] include: [101] a pet pad, [102] a second child pad, [103] multiple other passenger pads, [104] important item reminder inputs. Outputs may be, but are not limited to: [201] a reminder in the form of an alarm, a beeper, a voice or musical message, etc., [202] a cell phone message to the caregiver, [203] a fan, [204] a call to first responders, [301] one or several corrective actions which could be incorporated into the unit and/or wired into the vehicle systems.

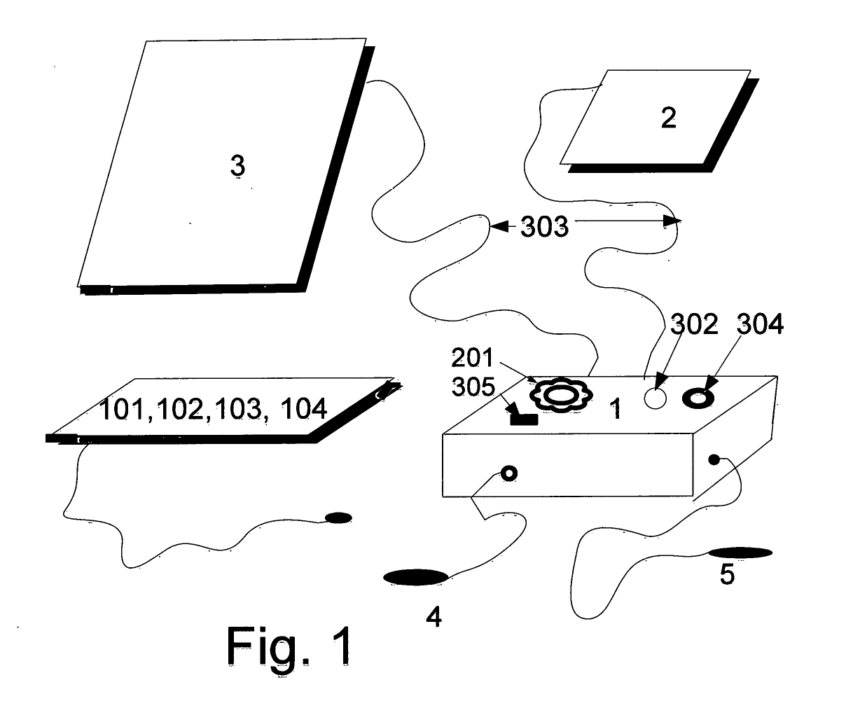

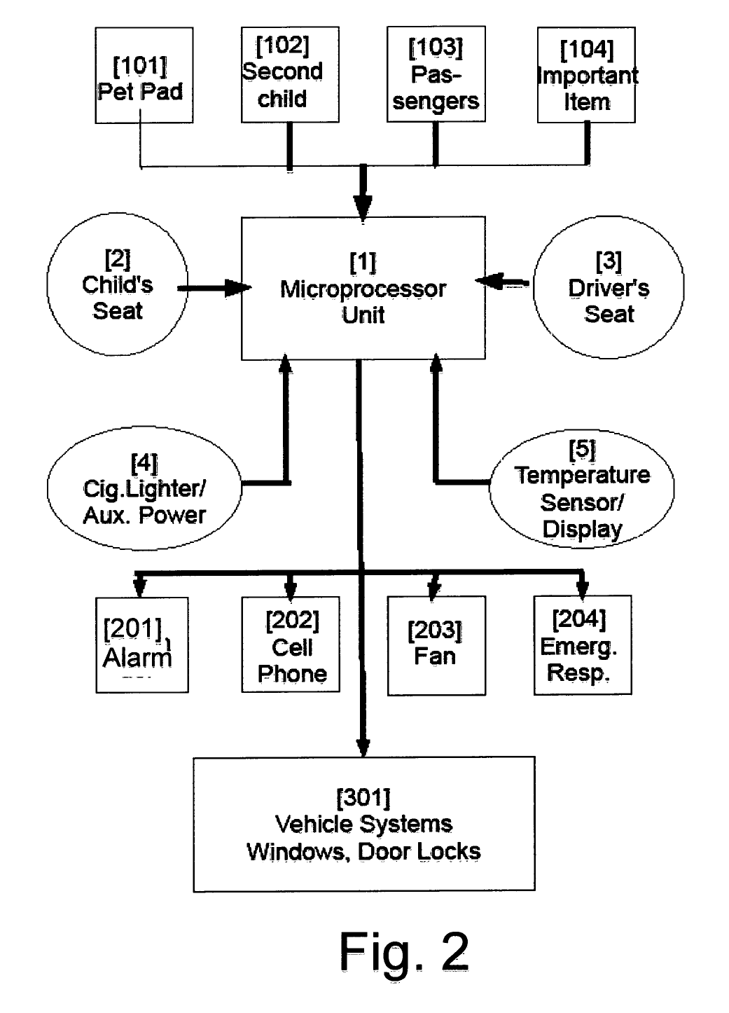

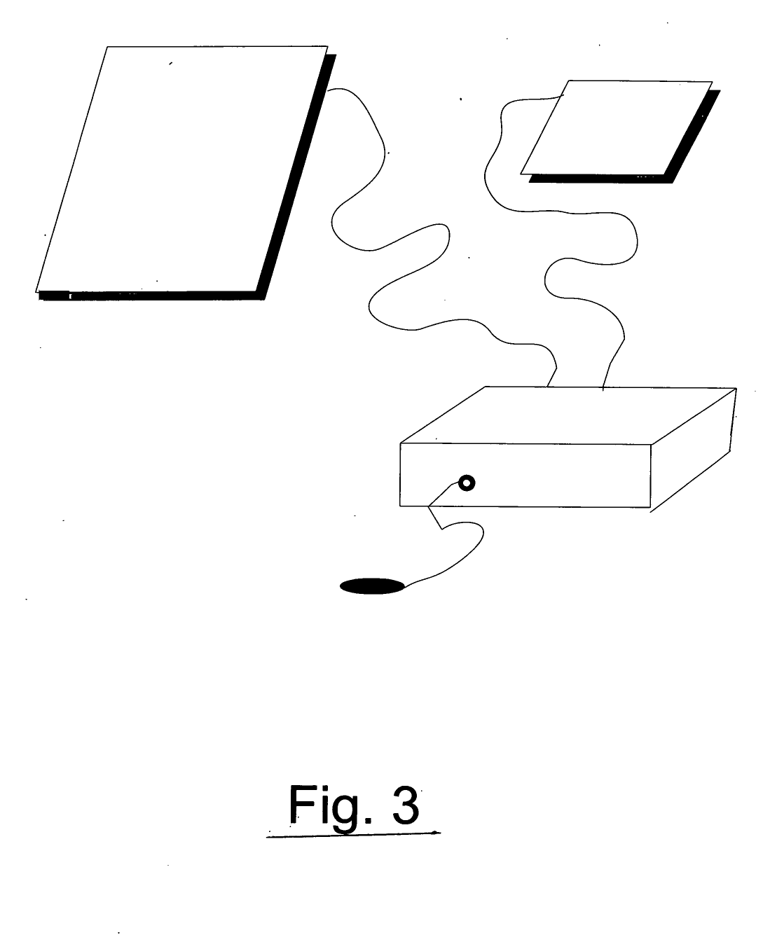

### DETAILED DESCRIPTION OF THE PREFERRED EMBODIMENTS

Typically, the device described herein would still be in the vehicle in which it is normally used. However, in the event that it had to be moved to another vehicle, it would be a simple matter to transfer it. In order to use the invention in its preferred embodiment, the caregiver would first place the child pad [2] in the child's car seat. If there is another child, pet, or other item, additional pads [101], [102], [103] may be employed.

The child is then placed in his or her seat on top of the pad [2]. Sensing the presence of an occupant, a circuit within the controller [1] is armed to emit an alert at predetermined intervals to remind the caregiver that the unit must be turned on. He/she accomplishes this by means of the switch [305] on the controller [1] or plugging said controller [1] via the auxiliary plug [4] into the vehicle cigarette lighter socket or other power supply. An indicator light [304] is illuminated whenever the unit is on to remind the driver to turn it off in order to save the battery.

Additionally, and independent of the forgoing alarm [201], which is only to remind the caregiver to turn the unit on, the weight of the child initiates a timer which gives the driver a reasonable amount of time to extend the connecting wires [303] and position the driver's seat pad [3] and occupy his seat pad [3] before a second reminder alarm [201] goes off.

Failing to having been plugged in to the auxiliary power, the unit will still operate on its own internal battery. If the caregiver cannot take his seat in the predetermined time, the controller [1] will once again alert. Simply pressing the reset button [302] on the controller will restart the timing sequence.

Any time the driver leaves his seat pad [3], the alarm [201] will sound once to remind him/her that the child is still on its seat pad [2]. The timer within the control will start once again to temporarily quiet the alarm [201]. Now the driver can use the reasonable time to retrieve the child. In the event the driver takes too long to either put the child in, or take the child out, of its seat, there is a reset button [302] which the driver can use to restart the timer.

Since the controller [1] logic requires that a certain sequence of events takes place, i.e. that the child seat pad [2] signal happens prior to the driver seat pad [3] signal, different sizes of pads are employed for the child and the driver. In this way, the pads are not likely to be interchanged and sequence is assured.

The several objectives strived for in this invention include: self containment, simplicity, ease of use, light weight, portability, versatility, and economy. In the case of the preferred embodiment, there is no need to make any modifications to the vehicle or the child's seat.

Beyond the basic features described above, the use of a programmable microprocessor controller opens up the possibilities of adding some very useful additions:
1). The child's pressure sensitive seat pad [2] may be form fitted to the seat; whereas the driver's seat pad [3] may be a flat cushion. Either, or both, pressure sensitive pads could be built into the automobile or child safety seat as an OEM feature.
2). Different size/shape pads could be employed for different uses, i.e. long rectangular pads [101], [102], [103] could cover the entire back seat to be used for pets or passengers. The same style pads could be used in vans or school buses to alert drivers of remaining occupants. Similarly, those same types of pads could be used to hold items such as a briefcase or groceries which would serve as a reminder that the vehicle needs to be unloaded.
3). The wires [303] which connect pads [2,3,101,102,103,104] to the microprocessor unit [1] need only to be long enough to extend throughout the automobile in the present embodiment of the invention, but extension wires could be employed to accommodate the uses described in 2), above, and 10) below. Alternatively, a wireless system could be employed.
4). A Temperature sensor [5] may be employed to further increase the capabilities of the unit. Such an addition could include, but not be limited to: a digital readout of the temperature in the automobile, an alarm [201] if the temperature exceeds or falls below, preset points, further, more dramatic actions such as turning on a fan [203], opening car windows [301], calling the driver's cell phone[202], calling emergency responders [204], etc. could be employed.
5). In the present embodiment, the unit contains its own battery, which may be dry cell or rechargeable. There is also a provision for an auxiliary input such as a cigarette lighter receptacle, transformer, or other auxiliary power supply [4]. In the event that auxiliary power is employed, the on/off switch [305] of the unit is overridden, and the internal battery may be being recharged, if a rechargeable one is used.
6). In the event that both the driver's pad [3] and child's pad [2] are filled, but the unit's [1] on/off switch [305] is in the “Off” position, and no auxiliary power [4] is employed, there is a provision for the unit [1] to “Beep” or otherwise alert the driver at regular intervals to remind the caregiver to energize the unit [1] via the on/off switch [305].
7). There is also a provision to alert the driver that the child has climbed off of his/her car seat pad [2], or the pad [2] is out of position, but the driver is still on his/her seat pad [3].
8). The basic unit (which consists of the controller [1], the child pad[2], the driver pad [3], and connecting wires [303]) is portable and versatile. It is small and flexible enough to be easily transferred between two or more vehicles which may be used on different occasions. It is light and compact enough to be carried on a trip to be used in a rental car.
9). If the caregiver is other than the driver, it is possible that the driver's pressure sensitive pad [3] could be used on the passenger's seat of the vehicle to remind the caregiver to remove the child.
10). Another possible use of the invention would be as a home alarm system. A switch on the microprocessor unit [1] could change the operation such that either of the pads [2], [3], would initiate the alarm[201] within the controller [1]. In this manner, a pad or several pads [2], [3], placed in front of one or more doors or windows would set off the alarm, warning the family of an intruder.
11). One or more pads [2], [3], placed in front of the bed of a person needing assistance during the night would alert the caregiver that the person has gotten out of bed and stepped on one of the pads. This feature would be especially useful when the child becomes old enough to climb out of his/her crib.
12). Many elderly or infirmed persons could also benefit from the system described in 11), above, so that a caregiver would automatically be alerted when that person got out of bed.

1. We claim a child-in-car reminder device designed to both detect and alert the presence of a child in a vehicle before the driver or caregiver exits the vehicle. The system consists of a child's seat pad [2], a driver's seat pad [3], and a plurality of optional sensors [101,102,103,104], a control unit [1], and a means to connect the controller with the pads [303]. The control unit contains, but is not limited to, a microprocessor or other means by which to discern a sequence of events and emit an alarm in the event that the sequence is violated, the alarm device [201], an on/off switch [305], an indicator light [304], a reset button [302], an internal power supply, and a means to connect said controller [1] to an external power supply [4].

2. The system according to claim 1 wherein the seat pads [2,3,101,102,103,104] contain sensors capable of detecting the presence of an occupant.

3. The system according to claim 1 wherein the controller's sequence of events is programmed to detect a presence in the child's pad [2] or additional pads [102,102,103,104], then allow a preset length of time for the driver's pad [3] to be occupied before an alarm [201] is initiated.

4. The system according to claim 1 wherein the sequence of events includes a provision to sound the alarm [201] if the child's seat pad [2] becomes unoccupied while the driver's pad [3] is still occupied.

5. The system according to claim 1 wherein the sequence of events includes a provision to sound the alarm [201] as soon as the driver's pad becomes unoccupied.

6. The system according to claim 1 wherein the sequence of events includes a reset button [302] with a provision to delay the alarm for a preset time to allow the caregiver to complete a task such as placing a second child or pet on an extra pad 101,102,103,104].

7. The system according to claim 1 wherein the sequence of events includes a provision to depress the reset button [302] several times to lengthen the delay in order to allow the caregiver to complete lengthy tasks such as pumping gas before sounding the alarm [201].

8. We further claim a control unit [1] for a child-in-car reminder device designed to both detect and alert the presence of a child in a vehicle before the driver or caregiver exits the vehicle. The control unit [1] of said device is designed to alert a driver or caregiver of the presence of a child, handicapped person, pet, or other item in the vehicle which needs to be removed before the driver or caregiver exits the vehicle. The controller receives inputs from a child's seat pad [2], a driver's seat pad [3], and a plurality of optional pads [101,102,103,104]. The control unit [1] contains, but is not limited to, a microprocessor or other means by which to discern a sequence of events and emit an alarm [201] in the event that the sequence is violated, an alerting device [201], an on/off switch [305], an indicator light[304], a reset button [302], provisions for auxiliary power input(s) [4] and an internal battery or other power supply.

9. The system according to claim 8 wherein the on/off switch[305] serves to allow the unit to be shut down during times when it is not being actively used, in order to preserve the life of the battery.

10. The system according to claim 8 wherein the controller [1] contains an indicator light to show its status and to serve as a reminder to turn it off when not in use.

11. The system according to claim 8 wherein the controller [1] contains a separate circuit which is independent of the on/off switch [305] and is capable of emitting an alarm to remind the user that the unit needs to be turned on or plugged in so as to cause the unit to operate in its intended mode.

12. A circuit according to claim 8 which is activated by an independent sensor in the child's pad, and energized by the power supply of the controller [1] that activates an alerting device [201] as a reminder that the controller must be turned on via its switch or plugged in to an auxiliary supply via [4].

13. The system according to claim 8 wherein the controller [1] can be powered by an auxiliary input such as the vehicle cigarette lighter socket [4] or other auxiliary input. When the unit is operated in this manner, It will both activate the controller [1] bypassing the on/off switch and recharge the unit's battery in the event a rechargeable battery is used.

14. The system according to claim 8 wherein the controller [1] has additional jacks to accommodate the use of the optional sensors [101,102,103,104].
